(19) United States
(12) Patent Application Publication
(10) Pub. No.: US 2003/0014315 A1
(43) Pub. Date: Jan. 16, 2003

(54) Method and a system for obtaining services using a cellular telecommunication system

(76) Inventors: Harri Jaalinoja, Helsinki (FI); Juha Koponen, Helsinki (FI); Petteri Koponen, Espoo (FI); Andrei Kustov, Espoo (FI); Lauri Pesonen, Helsinki (FI); Juha Paajarvi, Helsinki (FI); Juhana Rasanen, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/148,695

(22) PCT Filed: Dec. 4, 2000
(86) PCT No.: PCT/FI00/01073

(30) Foreign Application Priority Data
Dec. 3, 1999 (EP) 99660186.0
Apr. 12, 2000 (FI) 20000871
May 19, 2000 (FI) 20001213

(51) Int. Cl. G06F 17/60

(52) U.S. Cl. 705/18

(57) ABSTRACT

The invention relates to methods and systems for allowing users of a cellular telecommunication system to obtain services, goods, or other benefits from a third party. The invention allows the user to order a token from a token issuing system, receive the token to his mobile communication means, and obtain a service, goods, or some other kind of benefit by communicating the token to a verifying system, which verifies the token and allows the user to obtain the desired service.

### BACKGROUND OF THE INVENTION

1. Field of the Invention

The invention relates to methods and systems for allowing users of a cellular telecommunication system to obtain services, goods, or other benefits from a third party. Especially, the invention is related to such a method as specified in the preamble of the independent method claim.

2. Description of Related Art

Presently the use of mobile communication means such as mobile phones is increasing rapidly. Various schemes for the use of electronic money have also been presented. Despite these technological developments, large amounts of various bits and pieces of paper such as tickets and vouchers are still used. For example, for obtaining a right to see a movie, a person needs to go and buy a paper ticket, often queuing for most popular shows. Some Internet sites of ticket agencies allow the purchase of tickets via the Internet, however, the paper tickets are then mailed to the customer. The applicants are not aware of solutions employing the advantages of mobile communication systems giving the same advantages as paper tickets, such as the possibility to distribute the tickets to a group of people, or the possibility to buy and obtain the tickets early, and use them later.

### SUMMARY OF THE INVENTION

An object of the invention is to realize a method and a system for obtaining and granting rights, which alleviates the problems of prior art.

The objects are reached by arranging a token issuing system to issue tokens associated with specific rights and transmit such tokens to mobile communication means of users, and arranging a verifying system to receive tokens from users and to grant rights associated with presented tokens.

The system for granting and obtaining rights according to the invention is characterized by that, which is specified in the characterizing part of the independent claim directed to a system for granting and obtaining rights. The method according to the invention is characterized by that, which is specified in the characterizing part of the independent method claim. The computer program element according to the invention is characterized by that, which is specified in the characterizing part of the independent claim directed to a computer program element. The dependent claims describe further advantageous embodiments of the invention.

The invention allows the user to order a token from a token issuing system, receive the token to his mobile communication means, and obtain a service, goods, or some other kind of benefit by communicating the token to a verifying system, which verifies the token and allows the user to obtain the desired service.

### BRIEF DESCRIPTION OF THE DRAWINGS

The invention is described in more detail in the following with reference to the accompanying drawings, of which

FIG. 1 illustrates the basic features of the invention,

FIG. 2 illustrates a ticket printing system according to an advantageous embodiment of the invention,

FIG. 3 illustrates a vending machine according to an advantageous embodiment of the invention,

FIG. 4 illustrates a system for granting and obtaining rights according to an advantageous embodiment of the invention,

FIG. 5 illustrates a method according to an advantageous embodiment of the invention,

FIG. 6 illustrates a system for providing an access control service according to an advantageous embodiment of the invention,

FIG. 7 illustrates a system for providing access control to an external network according to an advantageous embodiment of the invention, and

FIG. 8 illustrates a method for providing connections to an external network from a first network according to an advantageous embodiment of the invention.

Same reference numerals are used for similar entities in the figures.

### DETAILED DESCRIPTION OF THE PREFERRED EMBODIMENTS

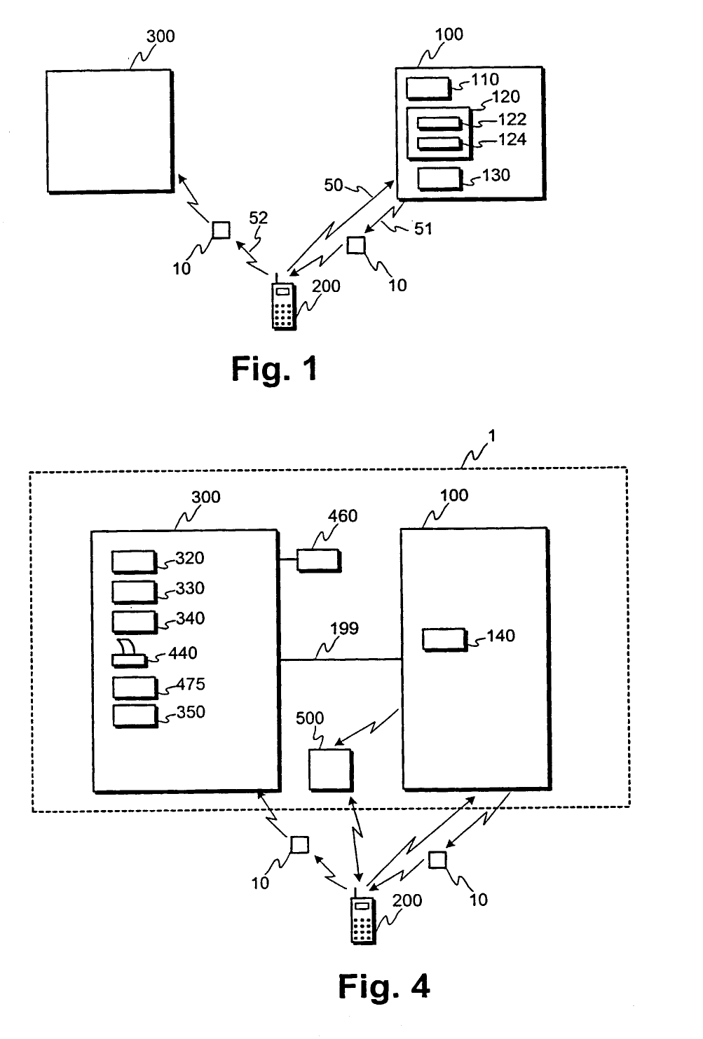

FIG. 1 illustrates the general structure of the invention. FIG. 1 shows a token issuing system 100, a mobile communication means 200, a token verification system 300 and tokens 10. The user of the mobile communication means 200 can use the invention by ordering 50 a certain token from the token issuing system, which produces a token 10 and transmits 51 the token to the mobile communication means. The user of the mobile communication means can then later use the token by effecting 52 the transfer of the token 10 to the token verification system, which receives and processes the token, and allows the user to obtain the benefit, right, or product associated with the token. In the following, the invention is discussed from various viewpoints generally, and with the help of more detailed descriptions of various advantageous embodiments of the invention.

### A. General Descriptions of Certain Features of the Invention

A.1. Ordering of Tokens

A user can order tokens 10 in many different ways, and can even receive tokens not specifically ordered by himself. The user can send a text message such as an SMS message for ordering a token, whereafter the issuer sends a token to the requester, possibly billing the user for the token. The user can as well call a telephone number of the issuer of the token with his mobile communication means, whereafter the issuer of the token can recognize the telephone number of the user and send a token as an SMS message to the user. In some embodiments of the invention, tokens can also be ordered via an Internet site of a token issuer using a HTML browser program or email. Similarly, a token issuer can also set up a WAP (wireless application protocol) service, which can be used for obtaining tokens by users having WAP-enabled mobile communication means 200. An issuer of tokens can also send tokens to users without explicit orders from the users. This can be advantageous for example for advertising and marketing purposes.

A.2. Generation of Tokens

Tokens 10 are generated by a token issuing system 100. The generation procedure of a token is naturally dependent on the type of the token. Different types of tokens are described later in this specification. FIG. 1 illustrates the structure of a token issuing system according to an advantageous embodiment of the invention. In this embodiment tokens are encrypted and digitally signed, whereby a token issuing system 100 comprises means 110 for receiving token requests, means 120 for generating a token according to a received token request, and means 130 for sending a generated token to the requester. In a further advantageous embodiment of the invention, the means 120 for generating a token comprise means 122 for encrypting a token and means 124 for digitally signing a token. These means 110, 120, 122, 124, and 130 can advantageously be implemented using software executed by the processor unit of the token issuing system.

The token issuing system can also generate tokens without explicit ordering by the user of the token. For example, the operator of the token issuing system can produce tokens with the system, and distribute produced tokens to users for example for promotional purposes. The generation of tokens can also be triggered by other events than receiving of an explicit request of an user or a request of the operator of the token issuing system. Examples of such other events are other transactions such as payments or purchases fulfilling certain criterions, or for example entering of a user to certain area in the cellular network.

A.3. Transmitting of a Token to a Mobile Communication Means

A token can be transmitted to a mobile communication means in many different ways. Since a token is a sequence of bits, a token can be transmitted to a mobile communication means basically using any method capable of transmitting a string of bits to the mobile communication means.

For example, in the present GSM networks an advantageous method is to use the short message service (SMS) to transfer tokens. In such an embodiment, the token can be encoded in a text message (SMS message) in many different ways. The encoding method naturally depends on the intended method of transferring the token from the mobile communication means to a verifying system. For example, in such an embodiment of the invention in which the token is transferred to a verifying system acoustically using a special alarm sound, the SMS message is preferably encoded in a way used in the prior art to transmit alarm sounds with SMS messages. If the user needs to transfer the token to a verifying system by using a keyboard, the token is preferably encoded using a short alphanumerical string.

The tokens can be transferred to a mobile communication means by email, if the mobile communication means is able to receive email. Further, a token can be transmitted to a mobile communication means with a pager network, if the mobile communication means is able to receive paging messages of a pager network.

In such embodiments, in which the mobile communication means is able to act as a terminal in a packet data network such as the GPRS network (general packet radio service), the token can be transferred in a single data packet, or for example using a specific packet protocol. In the example of the GPRS network, the token can be transmitted to the mobile communication means using a single IP (Internet protocol) packet. Other protocols on top of the IP protocol can also be used to transmit tokens. For example, in the case that tokens are transmitted by email, they can be transmitted using the SMTP protocol (simple mail transfer protocol).

In a further advantageous embodiment, the token is transmitted to the mobile communication means over a speech channel. In such an embodiment, the token needs to be encoded in an audio signal which can be transmitted over the speech channel. A man skilled in the art can encode a string of bits in an audio signal in many ways. For example, if the token is encoded using constant length notes with eight different signal frequencies, three consecutive bits of the token can be transmitted using one such note. DTMF signalling (dual tone multi frequency) can also be used. The received audio signal can be transferred directly to a token verification system, for example by holding the mobile communication means in close proximity to a microphone of the token verification system. In such embodiments in which the mobile communication means comprises means for recording speech signals, these recording means can be used to record the audio signal, which can then be played back later to a token verification system. d

A.4. Transferring of a Token from a Mobile Communication Means to a Verifying System

Tokens can be transferred from a mobile communication means to a verifying system in many different ways in various embodiments of the invention.

In an advantageous embodiment of the invention, the user of the mobile communication means types the token on a keypad of the verifying system. In such an embodiment, the token is preferably a relatively short numerical or alphanumerical string, which is short enough to facilitate easy typing without errors. In such embodiments, the token needs to be transmitted to the mobile communication means in such a way that the mobile communication means is able to display the token as a numerical or alphanumeric string on the display of the mobile communication means. Preferably, the token is transmitted in such an embodiment by short text messages or email messages.

In some further advantageous embodiments of the invention the token is transferred from the mobile communication means to the verifying system by optical means. For example, in an advantageous embodiment of the invention the verifying system comprises a scanning or image capture device for reading information on a display of the mobile communication means.

The verifying system can obtain an image of the display of the mobile communication means and use character recognition technology to interpret the contents of the display, i.e. the token shown as a sequence of characters on the display. In such an embodiment, the verifying system comprises a digital camera for obtaining the images. Such an embodiment has the advantage, that it only requires that the mobile communication means is able to display a character string transmitted to the mobile communication means, which means that virtually any GSM phone can be used in such an embodiment.

The verifying system can also recognize other shapes than characters from the display of the mobile communication means, such as predefined shapes designed for easy recognition. For that purpose, the communication means needs to be able to display such shapes. Such functionality is present already in some GSM phones at the time of writing this application, which phones have the capability of showing an image transmitted to the GSM phone as a specially encoded SMS message.

In one advantageous embodiments, the mobile communication means displays the token as a bar code on the display of the mobile communication means. Such an embodiment has the advantage that bar code readers typically used in point of sale equipment can be used to read the token instead of a more complicated and expensive camera and recognizing software approach. For that purpose, the communication means needs to be able to display bar codes, or simply images comprising the bar codes. Such functionality is present already in some GSM phones at the time of writing this application, which phones have the capability of showing an image transmitted to the GSM phone as a specially encoded SMS message. If such an image comprises a bar code, such a GSM phone is able to display the bar code.

In a further advantageous embodiment of the invention, the token is transferred using an optical link such as an infrared link between the mobile communication means and the verifying system. Such an embodiment has the advantage that the link is very simple and cheap to implement. Infrared links are also already present in many cellular phones at the time of writing of this application.

In a further advantageous embodiment of the invention, a local radio link is used for transferring a token between a mobile communication means and a verifying system. Such a radio link can be implemented in many different ways as a man skilled in the art knows.

In particularly advantageous embodiments of the invention, the token is transferred between the mobile communication means and a verifying system using acoustical means, such as using the alarm signal generating device or a loudspeaker of the mobile communication means to transmit the token, a microphone of the verifying system to receive the token, and a signal processing means of the verifying system to decode the acoustically transmitted and received token. In such embodiments, the audio signal for transferring the token to the verifying device can be generated either in the token issuing system, or in the mobile communication means. In the former case, the token is transmitted to the mobile communication means via a speech channel as an audio signal. The received audio signal can be transferred directly to a token verification system, for example by holding the mobile communication means in close proximity to a microphone of the token verification system. In such embodiments in which the mobile communication means comprises means for recording speech signals, these recording means can be used to record the audio signal, which can then be played back later to a token verification system.

In such embodiments of the invention, in which the audio signal is generated in the mobile communication means, the alarm signal generator, a loudspeaker, or the earpiece of the mobile communication means can be used to generate the audible signal. In a especially advantageous embodiment of the invention, an alarm signal of the mobile communication means is used to transfer a token. In such an embodiment the mobile communication means needs to be able to receive alarm signals encoded for example in a SMS message. Several GSM phone models already comprise such functionality at the time of writing of this patent application. According to the present embodiment, the token is encoded in the information describing a new alarm sound to the mobile communication means After reception of such information, the user of the mobile communication means is able to transfer the token to a verification system by playing the newly received alarm sound near a microphone of a verification system.

A particular advantage of acoustical transmission of tokens is the simplicity of implementation of such an acoustical link. Many already existing GSM phones have the capability of receiving alarm sounds encoded in SMS messages, and virtually all mobile phones are capable of reproducing an audio signal transmitted to the phone via a speech channel. Further, an audio signal is easy to receive and decode, which simplifies the construction of a verifying system. A conventional microphone and an amplifier suffices to receive the audio signal, and signal processing circuitry for decoding an audio signal is also straightforward to produce for a man skilled in the art. For example, DTMF (dual tone multi frequency) signalling can be used for transmitting the token. Circuits for generation and decoding of DTMF signals are easily obtainable and cheap.

### B. Detailed Description of Certain Features of the Invention

B.1. Token

A token is a piece of information associated with a right, i.e. a service or some other type of benefit which a verifying system is authorized to allow to a party presenting a token. A piece of information can be represented in many different ways, such as a string of bits directly stating the value of the token or in encoded form such as a string of characters or as an audio signal. The actual contents of the token can as well be constructed in many different ways in various embodiments of the invention.

In an advantageous embodiment of the invention, the token is an identifier of a right, i.e. the contents of the token have no other specific meaning than that of being associated with a right. In such an embodiment, the verifying system needs to have access to a memory means listing allowed identifiers and the description of rights corresponding to the particular identifier, if the verifying system is arranged to grant more than one different rights depending on the token presented to the system. Further, in such an embodiment the verifying system fetches a description of rights from the memory means on the basis of the received token, and proceeds to grant the user the benefits and rights described in the description of rights. For example, if the verifying system is a self-service ticket printer system at a movie theatre, the ticket printer could receive the string “asDsCX005” from the mobile phone of the user, use the string to obtain the description of the right associated with the string, such as “two tickets for 19.00 show of the newest James Bond film”, proceed to print the two corresponding tickets, and mark the tickets as printed in the memory means comprising the information about tokens and associated rights.

If the verifying system is arranged to grant only one specific right, it suffices that the verifying system compares the token to a predetermined identifier stored within the verifying system. The identifier may for example be a random string of characters. In such an embodiment, the right to be granted is already known by the verifying system, wherefore there is no need for explicit identification of the desired right by the token.

In an advantageous embodiment of the invention, the identifier of the right i.e. the value of a token is a result of a calculation performed on a string describing the right associated with the identifier. The calculation can for example be the calculation of a checksum or a hash value.

In a further advantageous group of embodiments of the invention, the token comprises the description of the right conveyed by the token. In such embodiments, the verifying system examines the contents of the token, and proceeds to grant the user the benefits and rights described in the token. For most practical applications, the token must be encrypted and/or digitally signed to prevent any attempts to produce false tokens by malicious users. Many different encryption methods can be used in various embodiments of the invention, and a man skilled in the art can easily implement many different methods. The encryption method should be sufficiently strong with regard to the commercial value of the benefit or right conveyed by the token. In one advantageous embodiment, public-key cryptography is used to encrypt the contents of the tokens. In such an embodiment, the token issuing system encrypts the contents of the token with its secret key, and the token is decrypted by the verification system using the public key of the token issuing system. If the verification system is able to decrypt the token using the public key of the token issuing system, the verification system can safely assume that the token was created by the token issuing system. In another embodiment, the token issuing system creates a digital signature of the token, and transmits the signature together with the token. Upon receiving the token and the signature, the verification system verifies the signature, and if the signature is acceptable, the user presenting the token is granted the benefits or rights described in the token. Such digital signature creation and verification can be effected for example using public key cryptography. In one advantageous embodiment of the invention the token issuing system calculates a checksum or a hash value of the token and encrypts the checksum or the hash value using the private key of the issuing system, the result of the encryption being the digital signature. When the verification system receives the token and the signature, it decrypts the signature using the public key of the issuing system, performs the same calculation as the issuing system, and compares the calculated and decrypted values. If the values match, the token can be safely assumed as being created by the token issuing system and as being unmodified during transmission. Such an embodiment has the advantage, that the contents of the token can also serve as a title or a name of the token, i.e. describe for the user which benefit or right is conveyed by the token. In a further advantageous embodiment of the invention, in addition to the digital signature, the contents of the token are encrypted as well.

In one embodiment of the invention, misuse is prevented to a sufficient degree by using a relatively large but scarce name space, i.e. by using long tokens. For example, such a token could specify in clear text the right conveyed by the token. The order of items specified in the token can be varied as well as the way in which they are specified to produce a large number of possible combinations for specifying a certain benefit or a service. When the number of combinations is large enough and only one predetermined combination is correct, the guessing of a token becomes infeasible. The number of combinations can also be arbitrarily increased by adding randomly chosen characters in the token.

In an advantageous embodiment of the invention, the token is generated by generating a hash value and truncating the hash value to a suitable length, which allows the entry of the token by hand. In such an embodiment the hash value is advantageously calculated from a combination of a secret key known by the token issuing system and the verification system, and of information describing the right conveyed by the token. The verification system can verify the token by producing combinations of the secret key and all possible descriptions of rights which it can grant, generating a hash of each combination, and truncating the hash in the same way as in the issuing system, and comparing the received token to generated truncated hash values. If a match is found, the corresponding right is granted. If no match is found, the token is rejected. Such an embodiment is feasible, when the number of rights which the verification system can grant is not too large in relation to the computing power of the verification system, so that the verification system is able to generate truncated hashes for all possible combinations of rights and any parameters associated with a right. Such an embodiment has the advantage, that the desired level of security can be easily defmed by choosing of the number of characters left after truncation. For short-lived and/or unexpensive rights the tokens can be short, and for valuable rights the tokens can be longer to reduce the chance of guessing a correct token. Further, such an embodiment allows generation of relatively short tokens, which are easy to enter using a keyboard or a numeric keypad. A combination of ten letters already gives a large number of possible tokens, making it very hard to guess a correct token, but ten letters is still sufficiently short to be entered manually without difficulties. Further, despite the relatively short length of the token, the calculation of the hash and the resulting token can be made dependent on any number of parameters such as service identifiers, user identifiers, mobile device identifiers, mobile phone numbers, and validity periods.

Further, the token can comprise a hint which gives some information about a right conveyed by the token, which allows the use of truncated hashes even in the case, when the total number of all possible rights would be infeasibly large to go through during verification of a token. For example, the truncated hash can be combined with a short character string to form a token, which string then identifies a class of rights, for example a class of services, or a range of parameter values for rights, such as validity periods. In essence, the character string is used to point out a subset of all possible combinations of rights and associated parameters, which subset is then small enough to be checked against match to a presented token.

The token may comprise many different types of information in different embodiments of the invention. The token can comprise the name or identifier of the right, such as for example “ticket”, “right to enter through this door”, or “candy bar”. Further, the token can comprise the identifier of a verifying system, in which case only that verifying system allows the user to obtain the benefit associated with the token. The token can also comprise the identifier of the token issuing system. The token can also comprise an identifier identifying the user. For example, the identifier identifying the user can comprise the subscriber number of the mobile communication means which the user used in ordering the token. In such an embodiment, the verifying system can store the user identifier, which can be used for subsequent billing of the user.

In such embodiments of the invention in which the token is used for obtaining a printed ticket, the token can comprise a part or all of the text printed on the ticket. In a further embodiment of the invention, the token comprises a complete description of the contents of the printed ticket for example as an image or in a page layout language such as PostScript or PCL, whereby the design and graphics of the printed ticket can be determined completely by the token. This allows the same ticket printer system to be used for printing tickets for a plurality of services.

The token can also comprise information specifying certain conditions which must be met when using the token. One example of such a condition is a validity period, which states the time period during which the token must be used. The validity period can be a single validity period, such as “valid for the next 10 minutes after token ordering time of 13:42”, or for example a repeating validity period, such as “every day 08:00-16:00”. Other conditions according to a particular implementation of the invention can also be stated.

The token can also specify the number of rights conferred by the token. One token can for example be used a certain number of times. For example, a user can obtain a token as a serial ticket to a movie theater, in which case the ticket printer system of the movie theater accepts the token for the printing of, say, five tickets. The buyer of such a token can then pass the token to a group of people, and the first five persons to present the token to the ticket printing system obtain a ticket.

In a further advantageous embodiment, the token can also confer partial rights. For example, the verifying system can require a specific set of tokens such as two specific tokens to be passed, before allowing entry via a specific door. Such a system could be used for example for security control of high security areas, allowing certain visitors having a token to pass through a door only with the company of another person such as a guard presenting his token to the verifying system. Methods for creating such partial rights are well known for a man skilled in the art and are described in detail for example in the IETF documents RFC 2692 and RFC 2693 describing the SPKI system. These RFC:s describe a system, in which the contents of two or more keys are needed in order to decrypt a document, perform a signature, or to verify a signature. For example, the verifying system may grant the right associated with the tokens after the presented tokens in combination can be used to successfully verify a signature of a key document in the verifying system. However, other types of mechanisms can also be used in embodiments requiring more than one token. In one embodiment of the invention, the contents of the required tokens merely identify the tokens, and the presence of the required tokens suffices for granting the right associated with the set of tokens. Further, the verifying system may require that the tokens be presented in a certain order. In a further advantageous embodiment of the invention, a certain number of tokens from a specific set of tokens need to be presented before obtaining the right associated with the set of tokens. That is, k tokens out of a set of n specific tokens must be presented, where k and n are positive integers, and k≦n.

In an advantageous embodiment of the invention in which tokens with partial rights are used, such tokens are associated with an identity of a user or a mobile device of a user for hindering the delegation of tokens to other persons. In such an embodiment the user needs to present the token and to identify himself in some way, or the mobile device used for presenting the token needs to identify itself. For example, the mobile device can be required to show its device identification number, such as an IMEI number of a GSM phone, for instance. The user can identify himself with a password, or for example using a mechanical key, a magnetic card, or a smart card.

Many different kinds of rights or benefits can be associated with a token. In an advantageous embodiment of the invention, a token can be used as an entrance ticket to a show, a movie, a theatre play, a museum, or for example an exhibition. A token can be presented at the entrance to the event, or for example to a ticket printing system connected to a verifying system in order to obtain a ticket for the event. In such an embodiment, in which the user presents a token to a ticket printing system and obtains a corresponding ticket, the user can obtain any benefit which can be obtained using some kind of a ticket. Further, a token can be used as a ticket for transportation, such as a bus or a train ticket. A token can also be used as a seat reservation ticket in a train, for example. A token can be used as a voucher as well, for example for the payment of a single trip in a taxi or a night in a hotel, in which case the token needs to contain enough information about the issuer of the token in order for the taxi company or the hotel to bill the issuer. A token can also be used as a key or an authorization to enter specific parts of buildings. Further, a token can also be used as payment for parking of vehicles. For example, a parking coupon printing system can comprise a verification system, whereby users can present a token to the parking coupon printing system for obtaining a parking coupon. For parking places and parking garages having gates at the exit, a verification system or a token receiving device connected to a verification system can be installed in the gate opening system, whereby the users can present a token to the gate opening system in order to open the gate instead of effecting payment through conventional means. In such an embodiment, a shop can send tokens to its customers allowing free parking for promotional purposes, or a cashier of a shop send a token to each customer whose purchases exceed a specified limit. Similarly, a company can send tokens allowing parking in nearby parking garages for its employees and visitors. A company might send a one-time token to a visitor, and a token corresponding to a monthly parking permit to an employee. Further, the entry gate of the parking lot can have means for transferring an entry token to a user's mobile device. The user can then present the entry token to a payment machine or at cashier's of the shop who owns that parking place, and obtain an exit token from the payment machine or the cashier's after paying for the parking.

Any other services can as well be associated with a token. For example, a shop in a shopping mall might send a token allowing the customer to have a free lunch at a local fast-food restaurant, if the purchases of the customer exceed a specified limit. A shop might as well send tokens associated with promotional offerings, various discounts and other benefits for regular customers. The previous uses of a token were only examples, and the invention is not limited in any way to these examples.

B.2. Token Verifying System

A verifying system can be implemented in many different systems according to various embodiments of the invention. For example, a verifying system can be a part of or be connected to a ticket printer system, a vending machine, an automated gate, or some other automated device.

Further, in one embodiment of the invention the verifying system is connected to a smart card writer system able to write information into smart cards. In such an embodiment, the right associated with the token is information to be written on a smart card. Such information may be for example a bus ticket, a number of bus tickets, or for example a monthly ticket. Such an embodiment can be used for sale and distribution of tickets for users of a smart card based ticket system, for example. Such a smart card writing system can be installed for general use at bus stations, for example.

As discussed previously in this specification, description of the right associated with a token can be stored in a database accessible to the verifying system, or the description may be included within the token, whether encrypted totally, in part, or not at all. However, the invention is not limited to these two embodiments, since in some advantageous embodiments of the invention a part of the description may be in the token, and another part in the database. The database may also comprise other types of information associated with the token as the description of the right associated with the token. For example, the database can comprise a password or a PIN number (personal identification number) which the user must input to the verification system in addition to the token. Such a password or a PIN can also be included in the token itself in encrypted form.

A verifying system can in some embodiments of the invention be arranged as a stand-alone system without connections to other systems. A stand-alone system cannot check, if a token presented to it has been presented to other verification systems or not. In such embodiments, it is preferable that the number of times a token is presented to the stand alone verifying system is irrelevant, or that the particular verifying system is the only verifying system accepting those tokens that can be used at the site.

In further embodiments of the invention, a plurality of verifying units are interconnected. Such a configuration is advantageous in such a site, where there are a plurality of verifying systems, all of which can accept token valid at the site. In such an embodiment, the verifying systems can check, if a particular token has already been presented to another verifying system at the site.

B.3. Token Storage Service

According to a further advantageous embodiment of the invention, a token storage system is provided. The token storage system can store a plurality of tokens of a plurality of users. A user can store tokens he has obtained from various token issuing systems in a token storage system, and later retrieve a token from the token storage system to his mobile communication means.

Such a token storage system is advantageous, if the user does not wish to store all his tokens in a mobile communication means. Further, such a token storage system allows a user to obtain tokens via other means than the mobile communication means. For example, a user can obtain tokens from an Internet site using a personal computer, and store the tokens in his own account in the token storage system. The user can then later fetch a token from the token storage system into his mobile communication means, and use the token. In an advantageous embodiment of the invention, the token storage system comprises a WAP (wireless application protocol) interface or a HTML (hypertext markup language) interface, which allows the user to browse the contents of his account on the token storage system with a WAP—or Internet-enabled mobile communication means. Preferably, the token storage system stores the tokens in unencoded form, and the user can choose, in which form he wishes to obtain the tokens: in an SMS message, encoded as alarm signal information in an SMS message, or any other form. The form in which the token is transmitted to the mobile communication means can also be dependent on the method the user uses to contact the token storage system: if the user places a speech call to the token storage system, the token storage system preferably encodes the token in an audio signal and transmits the audio signal to the mobile communication means over the speech channel.

B.4. Billing Issues

Many different methods can be used in various embodiment of the invention for billing the user for the service or right conveyed by a token, in such applications of the invention in which billing is necessary. In certain embodiments of the invention, the billing of the user is effected when the user orders the token. Such an approach can be easily implemented for example when the token issuing system issues tokens based on requests sent as a SMS message, in which case the cost of the token is added to the telephone bill of the subscriber sending the request SMS message. Similarly, when the token is obtained via a speech channel, the cost of the token can as well be added to the telephone bill of the user. In certain other embodiments of the invention, the billing is effected on the basis of usage of the tokens, i.e. the billing is effected only after a token is presented to a verifying system. In such an embodiment, information about used tokens need to be collected from verifying systems in order to enable the operator of the token issuing system to bill the user. Such an embodiment allows distribution of tokens to a potentially large group of people without need to pay for such tokens that remain unused. Such an embodiment is advantageous for example when a company wishes to offer a free movie to employees and distributes multiple copies of a token valid only for the particular movie, whereafter the movie theatre bills the company only for the actually used tokens. Many different ways for effecting a billing mechanism are easily devised by a man skilled in the art, and the invention is not limited to any particular method of effecting the billing of the user. Further, in some embodiments of the invention, a verifying system is arranged to accept both prepaid tokens and tokens requiring subsequent billing.

### C. Certain Particularly Advantageous Embodiments of the Invention

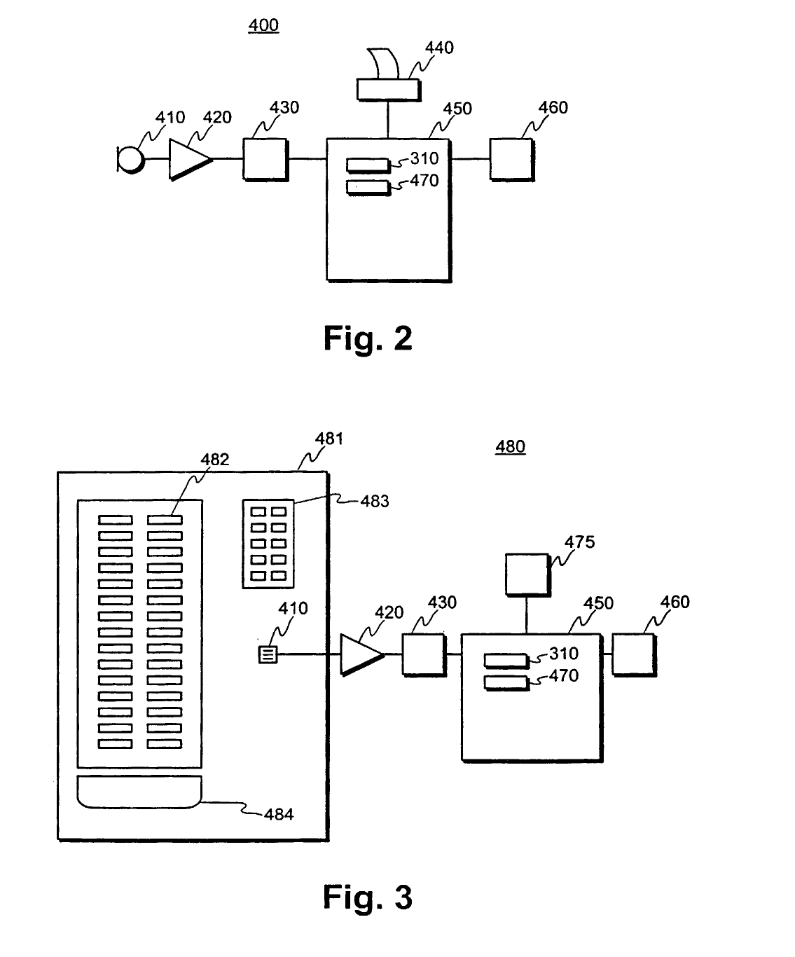

In the following, some particularly advantageous embodiments of the invention are described. According to a particularly advantageous embodiment of the invention, a ticket printer system is provided, which ticket printer system comprises functionality of a verifying system. The ticket printer system is illustrated in FIG. 2. The ticket printer system 400 is arranged to receive tokens from mobile communication means via acoustical means. For that purpose, the ticket printer system comprises a microphone 410 and an amplifier 420 for receiving audio signals and a signal processing unit 430 for decoding received audio signals. For printing tickets, the ticket printer system comprises a printer 440. The operation of the ticket printer system is controlled by a control unit 450. The ticket printer system further comprises a memory means 460 for storing information about received tokens and for storing programs directing the functioning of the ticket printing system. The ticket printing system further comprises means 310 for verifying received tokens, and means 470 for controlling the printing of tickets. According to this embodiment, the verifying means 310 is arranged to receive and accept encrypted and signed tokens issued by certain token issuing systems. The verifying means 310 is arranged to decrypt an encrypted token using the secret key of the ticket printer system, and verify the digital signature of the token issuing system. After decryption, the ticket printer system prints one or more tickets according to the contents of the token. The ticket printer system 400 is arranged to store public keys of those token issuing systems, whose tokens the ticket printer system accepts. The ticket printer system can be used in any application, in which printed tickets are exchanged for goods, services, and other benefits. Examples of such applications are ticket printer systems for printing vehicle tickets, movie tickets, service coupons, and discount coupons.

FIG. 3 shows another particularly advantageous embodiment of the invention. In this embodiment, a vending machine comprising a verifying system is provided. FIG. 3 shows a vending machine 480, having an user interface 481, products 482 to be dispensed, product selection buttons 483, and a dispensing bin 484. The products can be for example for candy bars, tobacco, or other products. The vending machine 480 is arranged to receive tokens from mobile communication means via acoustical means. For that purpose, the vending machine comprises a microphone 410 and an amplifier 420 for receiving audio signals and a signal processing unit 430 for decoding received audio signals. For dispensing products, the vending machine comprises a dispensing mechanism 475, which is arranged to drop products 482 to dispensing bin 484. The operation of the vending machine is controlled by a control unit 450. The vending machine further comprises a memory means 460 for storing information about received tokens and for storing programs directing the functioning of the vending machine. The vending machine further comprises means 310 for verifying received tokens, and means 470 for controlling the dispensing of products. According to this embodiment, the verifying means 310 is arranged to receive and accept encrypted and signed tokens issued by certain token issuing systems. The verifying means 310 is arranged to decrypt an encrypted token using the secret key of the vending machine, and verify the digital signature of the token issuing system. After decryption, the vending machine dispenses one or more products according to the contents of the token. The vending machine 480 is arranged to store public keys of those token issuing systems, whose tokens the vending machine accepts. FIG. 3 only shows one example of a vending machine, and the invention is not limited to such vending machines as shown in FIG. 3. The invention can be applied to any other known vending machines as well, for example to such systems in which the user can open a door after payment or transferring of a token, and pick the product he likes.

The systems of FIGS. 2 and 3 can be both used in a similar way. The user can for example obtain a token encoded as a SMS message describing a new alarm sound, and later play the sound at the microphone system of FIG. 2 or 3 to obtain a ticket or a product. The user can also place a telephone call to a telephone number of a token issuing system, and place his mobile phone near the microphone 410, whereby the token issuing system transfers a token encoded in audio signals via the mobile phone to the verifying system of the ticket printer or vending machine. There may be more than one telephone numbers listed on the system, each number corresponding to a given ticket or product or a type of tickets or products.

The systems of FIGS. 2 and 3 can in further embodiments of the invention also comprise any and/or all means described as being a part of various types of verifying systems described in the present specification.

### D. Further Advantageous Embodiments of the Invention

FIG. 4 illustrates a particularly advantageous embodiment of the invention. According to this embodiment a system 1 for granting and obtaining rights is provided. The system comprises a token issuing system 100 for issuing tokens 10 associated with specific rights, means for transmission 140 of tokens to mobile communication means, and a verifying system 300 for receiving tokens from mobile communication means and for verifying received tokens. The means for transmission 140 of tokens to mobile communication means can for example comprise means for generation of a SMS message and for transmission of the SMS message to a cellular telephony system.

According to a further advantageous embodiment, the system for granting and obtaining rights comprises in the verifying system means 320 for decrypting an encrypted token.

According to a further advantageous embodiment, the system for granting and obtaining rights comprises in the verifying system means 330 for verifying a digital signature.

According to a further advantageous embodiment, the system for granting and obtaining rights comprises a memory means 460 for storing descriptions of rights associated with tokens, and in the verifying system, means for obtaining 340 a description of a right from said memory means on the basis of a received token.

The memory means 460 can advantageously be a part of the verifying system, i.e. an internal memory means of the verifying system. However, in various embodiments of the invention, the memory means 460 can also be a part of the token issuing system 100, in which case the verifying system 300 needs to have a communication link with the memory means 460.

According to a further advantageous embodiment, the system comprises in the verifying system means 460 for printing a ticket.

According to a further advantageous embodiment, the system comprises in the verifying system means 475 for dispensing a product.

According to a further advantageous embodiment, the system comprises in the verifying system means for receiving a token presented as an acoustical signal. Such means can be for example a microphone 410, an amplifier 420, and a signal processing means 430.

According to a further advantageous embodiment, the system comprises in the verifying system means 350 for receiving a token optically. The means 350 for receiving a token presented optically can for example comprise a phototransistor and signal processing means for receiving infrared optical signals, or for example a bar code scanner.

According to a further advantageous embodiment, the verifying system and the token issuing system are connected via a communication link 199. This communication link can in various embodiments of the invention be used for example for transmission of tokens and corresponding descriptions of rights from the token issuing system 100 to a memory means of the verifying system. Further, this communication link 199 can also be used for transferring information about used tokens from the verifying system to the token issuing system.

According to a further advantageous embodiment, the verifying system is a stand-alone system. In such an embodiment, the verifying system is not connected via any hardwired link to the issuing system.

According to a further advantageous embodiment, the system further comprises means 500 for storing tokens generated for a user. In such an embodiment, the means 500 for storing tokens generated for a user provides token storage services as described previously.

According to a further aspect of the invention, a verifying system is provided. According to this aspect of the invention, the verifying system comprises means for receiving a token, means 310 for verifying a token, and means 440, 475 for allowing a user to obtain the right associated with the token.

According to a further advantageous embodiment, the verifying system further comprises means 410, 420, 430 for receiving a token presented as an acoustical signal.

According to a further advantageous embodiment, the verifying system further comprises means 350 for receiving a token optically.

According to a further advantageous embodiment, the verifying system further comprises means 320 for decrypting an encrypted token.

According to a further advantageous embodiment, the verifying system further comprises means 330 for verifying a digital signature.

According to a further advantageous embodiment, the verifying system further comprises a memory means 460 for storing descriptions of rights associated with tokens, and means for obtaining 340 a description of a right from said memory means on the basis of a received token. The means 320, 330, 340, and 350 can advantageously be implemented as software executed by a processor unit of the verifying system 300.

According to a further advantageous embodiment, the verifying system further comprises means 440 for printing a ticket.

According to a further advantageous embodiment, the verifying system further comprises means 475 for dispensing a product.

According to a further advantageous embodiment, the verifying system is a ticket printer system 400.

According to a further advantageous embodiment, the verifying system is a vending machine 480.

According to a further aspect of the invention, a method for granting and obtaining rights is provided. According to this aspect, the method comprises at least the steps of receiving 500 a token associated with a right, verifying 510 the received token, and allowing 590 a user to obtain the right associated with the token.

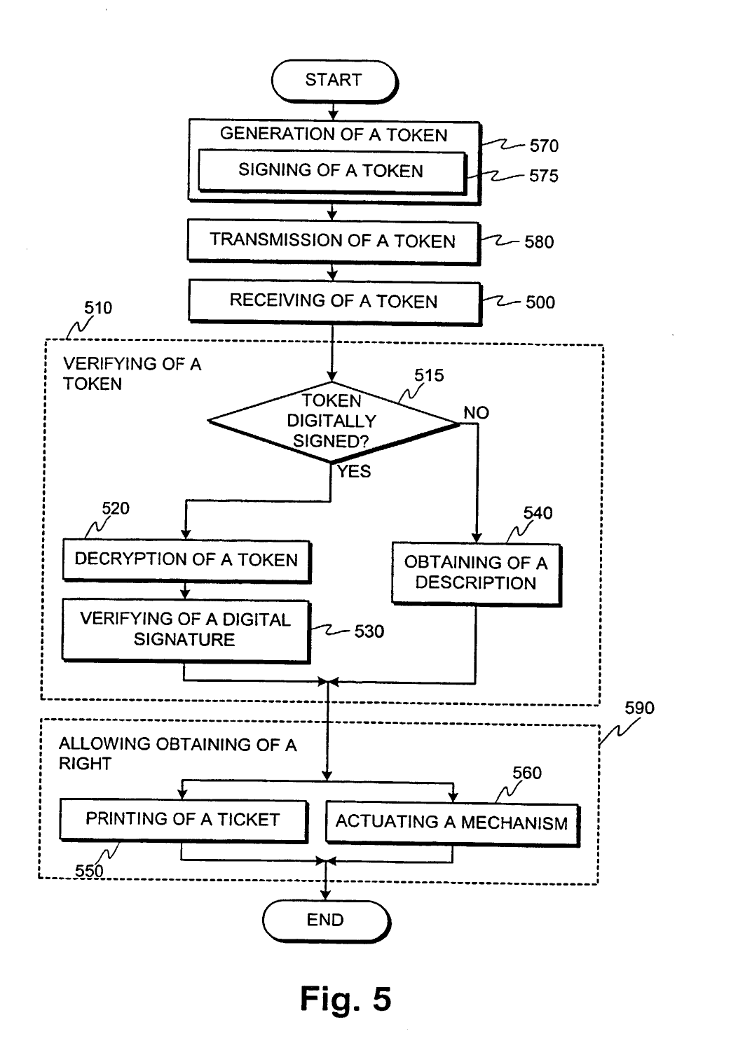

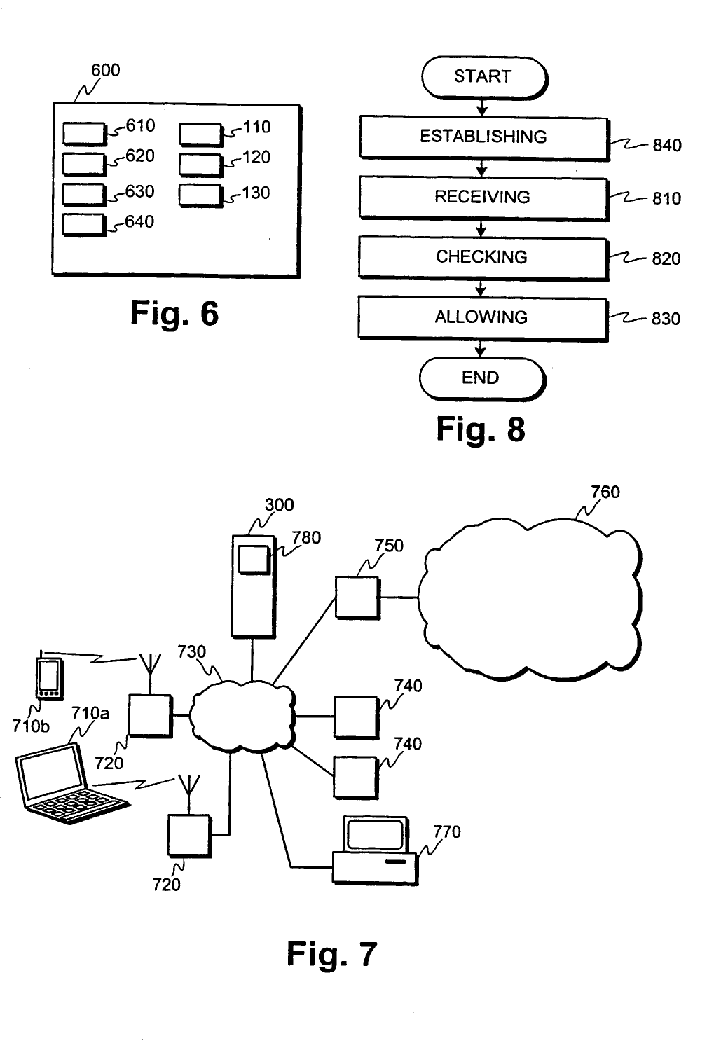

According to a further advantageous embodiment of the invention, the method further comprises at least the step of decrypting 520 a token. The step of decrypting 520 a token is in certain embodiments of the invention a part of the step of verifying 510 the received token, as shown in FIG. 5.

According to a further advantageous embodiment of the invention, the method further comprises at least the step of verifying 530 a digital signature in a received token. The step of verifying 530 a digital signature is in certain embodiments of the invention a part of the step of verifying 510 the received token, as shown in FIG. 5.

According to a further advantageous embodiment of the invention, the method further comprises at least the step of obtaining 540 from a memory means on the basis of a received token a description of the right associated with the token.

In an advantageous embodiment of the invention, the method further comprises the step 515 of checking, whether the received token is digitally signed. If the received token is digitally signed, then step 520 is performed if necessary, after which step 530 is performed. If the received token is not digitally signed, then a description of the right associated with the token is obtained from a memory means on the basis of the token. However, this is only one example of an advantageous embodiment of the invention, and does not limit the invention in any way. For example, in other embodiments of the invention in which no digital signing and encryption of tokens are used, the contents of the token are used as a direct description of the right associated with the token. Digital signing and encryption might not be necessary to avoid misuse by malicious users, if the tokens are for example transferred as encoded in audio signals, which are not easy to fabricate by a user without knowledge of the encoding used and the technical means to do it.

According to a further advantageous embodiment of the invention, said step 590 of allowing comprises at least the step of printing 550 a ticket.

According to a further advantageous embodiment of the invention, said step 590 of allowing comprises at least the step 560 of actuating a mechanism.

According to a further advantageous embodiment of the invention, the method further comprises at least the steps of generation 570 of a token, and transmission 580 of the generated token to a user.

According to a further advantageous embodiment of the invention, said step 570 of generation comprises at least the step 575 of digitally signing a description of a right.

According to an even further aspect of the invention, a computer program element for a system for granting and obtaining rights is provided. According to this aspect of the invention, the computer program element comprises at least computer program code means for receiving a token, computer program code means for verifying a token, and computer program code means for allowing a user to obtain the right associated with the token.

The computer program element can in various embodiments of the invention be provided as an independent application program, a program library for creation of systems for granting and obtaining rights, such programs or program libraries embodied on a computer readable medium, such as on a CD-ROM disc, or for example such programs or program libraries encoded on a carrier such as a data stream in a computer network.

In a further advantageous embodiment of the invention, the computer program element comprises computer program code means for interpreting a token received as an acoustical signal. Such computer program code means can be arranged for example to interpret DTMF signals contained in a digital data stream obtained from a microphone and a analog-to-digital converter.

In a further advantageous embodiment of the invention, the computer program element comprises computer program code means for interpreting a token received as an optical signal. Such computer program code means can be arranged for example to recognize characters or other shapes from an image of a display.

In a further advantageous embodiment of the invention, the computer program element comprises computer program code means for decrypting an encrypted token.

In a further advantageous embodiment of the invention, the computer program element comprises computer program code means for verifying a digital signature.

In a further advantageous embodiment of the invention, the computer program element comprises computer program code means for storing descriptions of rights associated with tokens, and computer program code means for obtaining a description of a right from said means for storing on the basis of a token.

In a further advantageous embodiment of the invention, the computer program element comprises computer program code means for controlling the printing of a ticket.

In a further advantageous embodiment of the invention, the computer program element comprises computer program code means for controlling the dispensing of a product.

### E. Embodiments According to a Still Further Aspect of the Invention

In an advantageous embodiment of the invention, a token conveys an access right to an account containing information about one or more types of benefits or services. For example, such a token can give a right to access an account containing a certain number of tickets, such as lunch tickets, bus tickets, or ski lift tickets. When such a token is presented to the verifying system, the number of tickets on the account is decremented by one. Such a combination of a token and a corresponding ticket account can be used for example by companies for providing lunch tickets for an employee. Such an account can hold more than one type of tickets; for example, in the lunch cafeteria scheme the account can advantageously hold tickets for lunches and tickets for cups of coffee or tea. In such an example, a coffee automat at the cafeteria receives tokens and dispenses cups of coffee, effecting the decrement of the number of coffee coupons in the coupon account by one each time a coffee is served to a user presenting a token corresponding to the account. In a corresponding way, if the user presents the token at the cashier's of the lunch cafeteria, the number of lunch coupons is decremented.

### F. Embodiments According to an Even Further Aspect of the Invention

According to a further advantageous embodiment of the invention, tokens are used for software license control and/or internet service access control. This embodiment is suitable for example for situations, in which a software producer or distributor wishes to offer software for free downloading but wishes to bill for the use of the program. Such a mechanism could be used for renting of software or for controlling the access of an internet based service, for example.

In an advantageous embodiment of the invention, an access control service provider provides a license control service for other parties such as software producers and distributors. Such a license control service can easily be implemented by cellular network operators and service providers. According to this embodiment, the user can obtain a license to use a certain program or a service for a certain time by sending an identifier presented by the program using his mobile communication means to the license control service. For example, short message service (SMS) can be used for this purpose, or for example email, or other text-based transmission methods. The license control service receives the identifier of the software, and produces a token by combining further information such as the validity period of the license to the identifier and signs and/or encrypts the result with the secret key of the software producer or the distributor. The license control service then transmits the token back to the user, who presents the token to the program. The program can then verify the token by decrypting and/or checking the signature of the token, and verifying that the token specifies the identifier of the program, and checking that the validity period has not ended yet and any other possible conditions are met. After verifying the token, the program allows the user to use the program for the specified period. The access control service provider then bills the user for the tokens he has obtained for example by adding the sum to his telephone bill. The access control service can then later gives a part of the payment to the software producer according to the agreement between the software producer and the access control service provider.

Such an embodiment has several advantages. Software producers can easily take such a system into use, since the access control service provider handles the connections to the cellular network, and the software producer only needs to include his public key and token receiving and checking software modules to his software, and to give the corresponding secret key to the access control service provider. For the user it is also quite easy to obtain the program and pay for it, since the user can freely download and install the software, and the license can be obtained simply by sending a text message, and entering the resulting response message to the program.

Such an embodiment also protects the privacy of the user, since it allows the use of an Internet service without revealing the identity of the user to the Internet service. Confidentiality is obtained, when the provider of the service used by the user is not the same party i.e. the access control service provider which issues and charges for tokens. Initially, the provider of the service needs to give a secret key to the access control service and agree on the payments to be charged for the users, whereafter the access control service can independently provide licenses to users without any further information from the provider of the Internet service.

The license token can comprise also other types of information and conditions for use than a simple time period.

Such an embodiment of the invention can advantageously be used both in such arrangements, in which the user downloads and installs the program, and in such arrangements, in which the user simply uses the program over the internet without any specific installation on his computer. Such an embodiment of the invention can also be used for any internet based service.

### G. Embodiments According to an Even Further Aspect of the Invention

According to an advantageous aspect of the invention, a system for providing an access control service is provided. According to an advantageous embodiment of the invention, the system 600 comprises at least

means 610 for receiving information about allowed parameters for services to be access controlled from a user of a first type,

means 620 for generating an encryption key,

means 630 for providing a generated encryption key to a user of said first type,

means 110 for receiving a request for a token from a user of a second type,

means 120 for generating a token, and

means 130 for transmitting a generated token to said user of said second type.

In this exemplary embodiment of the invention, the user of said first type is a service provider providing some kind of service to users of the second type via the internet.

Such a system allows service providers to add a token-based access control very easily to their services. Naturally, the service provider needs software modules for performing token verification. The service provider can access the access control service system via the internet and using said means for receiving information, enter any necessary company information such as a bank account for receiving payments for tokens sold by the system, and choose the operating parameters for his tokens. These operating parameters may comprise but are not limited to the following:

identifier of his service being provided or that of each of his services,

whether the tokens are one time tokens or can be used a certain predefined number of times,

whether the tokens have a period of validity,

what is the price of the tokens to be required from users,

what is the length of the tokens i.e. what is the cryptographic strength of the tokens against tampering,

and any other parameters of interest to the service. The service provider also needs to supply a key to the access control service system for use in encrypting and/or signing the tokens. In the present embodiment the access control service system comprises means for generating a key for use as a shared secret, which the service provider then downloads to his own system for verifying of tokens. In the present embodiment, the access control service system comprises means for providing a generated encryption key to a user of said first type, which means allow the service provider to download a file comprising the key and the associated type and parameter information of the tokens to be generated. The service provider then needs to arrange the key file to be available to those software modules at his service, which perform verification of tokens. In the present embodiment the access control service system comprises means for receiving a request for a token from a user of a second type, and when the system receives a request, it generates a token using said means for generating a token, and transmits the requested token to the requesting user using means for transmitting a generated token to said user of said second type. For example, a user may send a SMS message to the access control service system, which generates the requested token, charges the sum from the user, and transmits the token to the user, who can then access the desired service by entering the token.

Such a system has the advantage, that a service provider can start using tokens, or change the types of tokens being used very easily, simply by accessing the internet service of the access control service system.

According to a further advantageous embodiment of the invention, a system for providing an access control service is provided. According to this embodiment, the system 600 comprises at least

means 610 for receiving information about allowed parameters for services to be access controlled from a user of a first type,

means 640 for receiving an encryption key,

means 110 for receiving a request for a token from a user of a second type,

means 120 for generating a token, and

means 130 for transmitting a generated token to said user of said second type.

In various embodiments of the invention, an access control service system comprises means for receiving a key from a user of a first type for receiving a secret key of a key pair. The access control service system can then encrypt and/or sign tokens using that secret key, and software programs downloaded by users can then verify the tokens using the corresponding public key. In such an embodiment, an access control service system can also be used by software producers for providing license control for downloadable software programs.

### H. Embodiments According to a Further Aspect of the Invention

According to a further aspect of the invention tokens are used for controlling access to external network for wireless terminals connected to a local network. FIG. 7 illustrates a system for providing such functionality. FIG. 7 shows wireless terminals 710a, 710b, base stations 720 for the wireless terminals, a local area network 730, local servers 740, a gateway 750, which allows or denies access to a wide area network such as the internet 760, a token verification system 300, and computers 770 for network access in public locations such as internet cafes, where users can access a public network using computers 770. The wireless connection to the local area network can be effected by any short-range radio link, such as by using the well-known Bluetooth technology, or any other wireless local area network radio technology. The terminals can be portable computers 710a, personal digital assistants (PDA) 710b, or other devices equipped with a local radio link functionality.

According to an advantageous embodiment of the invention, the terminals 710 can access the local network 730 via the wireless base stations 720, and any services on servers 740 connected to the local area network without providing a token. If the user wishes to access the external network 760, the user needs to present a token to the token verifying system 300, which as a response to receiving and processing of a valid token from the user instructs the gateway 750 to allow communication to and from the external network to and from the terminal of the user. Such an embodiment allows easy wireless access to local information services, which is of advantage both to the users of terminals and the party managing the local network and the local information services. Examples of locations where such a system is advantageous are airports, conference and fair centers, shopping malls, amusement parks, train stations, sport centers, and in general any locations, where it is advantageous to provide local information services to people.

In an advantageous embodiment of the invention, the terminals are assigned an IP address, when they contact the local area network via the base station. The assigning of an IP address can be performed in any way known from the state of the art, such as procedures used in connection with dial-up Internet service providers. After having established a connection with the local area network and being assigned an IP address, the terminals can communicate with any devices connected to the local area networks. Such devices can be for example any local servers 740 acting as intranet and/or internet servers, i.e. providing access to certain intranet or Internet pages. The servers can also provide other functions, such as name service and NNTP news service. However, gateway 750 does not forward traffic to and/or from an IP address assigned to a terminal, unless the token verifying system 300 has indicated that the particular IP address may communicate with the external network. The token verifying system can specify a certain time window within which a given IP address corresponding to a certain terminal can communicate with the external network, the length of the time window corresponding to the value of the token presented by the terminal. The token verifying system can also retain the control of the time period at itself, by giving separate commands to allow and disallow communication to/from an IP address.

Gateway 750 can be implemented as a conventional firewall. However, the controlling rules of the firewall need to be under control of the verifying system 300, at least for the IP address space reserved for wireless terminal. The control by the verifying system can be arranged in many different ways. For example, the verifying system can be directly coupled to a terminal port of the computer implementing the functionality of the gateway 750, i.e. emulate a control console, whereby the verifying system can control the functioning of the gateway 750. As another example, the gateway 750 can be configured to receive control commands via the local network 730, whereafter the verifying system can control the gateway by sending commands via the local area network. As a third example, the functionality of the verifying system and the gateway 750 can be implemented in a single computer, whereby many other communication channels can be arranged, as generally known by a man skilled in the art in relation with interprocess or interprogram communication. However, for practical reasons such as computer security considerations it may be desirable to have the functionality of the verifying system be implemented on a host separate from the gateway, and within the local area network protected by the gateway 750.

In an advantageous embodiment of the invention, the verifying system can act as an intranet server providing an intranet page, which can be accessed by terminals connecting to the local area network via the local radio link, and which can be used for entering the token. In such an embodiment, the user can simply open the intranet page using browser software in his terminal, and enter the token for example in a field of a form provided on the page.

In a further advantageous embodiment of the invention, the inventive system comprises token receiving devices connected to the token verifying system. Such token receiving devices have been described previously in this application. Such token receiving devices can be for example infrared reception and transmission links, devices capable of receiving audio signals representing tokens, bar code scanners for scanning tokens represented as a bar code on the display of a terminal, or other types of devices capable of interpreting visual signals represented on display of a terminal.

Various ways of obtaining tokens in a mobile communication means have been described previously in this application, whereby descriptions of such methods are not repeated here. However, we note that the mobile communication means need not be the same device which acts as a wireless terminal 710; however, it can be the very same device. In such a case in which a user has two devices i.e. a mobile communication means such as an UMTS mobile phone and a terminal such as a portable computer equipped with a Bluetooth radio link, the user can give the token obtained using the mobile phone to the token verifying system via the portable computer. The transfer of the token can be effected manually, for example by the user typing the token in a field in an intranet page provided by the token verifying system and displayed by the terminal. The transfer of the token can also be effected using for example an infrared link or a radio link such as a Bluetooth radio link between the mobile communication means and the terminal, in which case software code means in the terminal is arranged to receive the token via the infrared or radio link and forward the token to the token verifying system.

In such a case in which the terminal 710 is also equipped with functionality of a cellular mobile communication means, in which case the terminal 710 can be a multifunctional mobile communication means or a personal digital assistant, the terminal can comprise program code means for forwarding a token to the token verifying system, whereby the user need not manually enter the token.

In a further advantageous embodiment, the local area network can also have services which require a token for access. In such a case, a server 740 providing such a service requires an indication from the verifying system that a terminal having a certain IP address is allowed to use the service, before allowing the terminal to use the service. The user then needs to provide a token to the token verifying system in order to use the particular service. Such an embodiment can be used for example for provision of VIP services, customer benefit services, or payable services. FIG. 7 shows only one token verifying system 300. In an advantageous embodiment of the invention, a server providing a service requiring a token for access comprises the functionality of a token verifying system of its own, in which case the server is not dependent on the token verifying system controlling the access to/from the external network.

In another advantageous embodiment of the invention, a terminal accessing the local area network via the local radio link is assigned a care-of IP address, if the terminal already has an IP address. This can be the case for example in connection with GPRS (general packet radio service) enabled cellular mobile communication means, which has an IP address associated with the device. According to prevalent schemes at the time of writing this patent application, mobility is provided in IP networks by arranging a mobile IP device to obtain a care-of address at a remote location, and arranging a home agent to send any traffic arriving to the IP address of the mobile device to the care-of address for reception by the mobile device. According to the present embodiment, the inventive system notifies the home agent of the terminal and forwards any traffic to and from the assigned care-of address only after the terminal has presented a valid token to the token verifying system. Such an embodiment is advantageous for example in such situations, in which a user wishes to avoid expensive connection time for connections via a cellular telecommunication network in a locality, which provides cheaper connections via a local radio link.

In a further advantageous embodiment of the invention, tokens are used to control access to an external network 760 from a public terminal 770 connected to a local network 730. Such an embodiment can be used for example in internet cafes libraries, or any other locations, where terminals are provided for public use. According to the present embodiment, the terminals can only access the local network 730 without a token. The gateway 750 allows traffic to and from a particular terminal only after the user of the terminal inputs a valid token to the token verifying system, which then instructs the gateway to allow traffic to pass in a similar way as described previously in connection with wireless terminals. Preferably, the user is required to enter the token via the particular terminal he wishes to use for accessing the external network, which allows the token verifying system to verify easily, which terminal should be granted access to the external network. If the user enters the token via another route such as an infrared receiver connected to the token verifying system, the token needs to be associated with information specifying, which terminal is to be granted access to the external network.

In a particularly advantageous embodiment of the invention, the token verifying system provides a local intranet page on the local network, whereby the user can open the page using browser software on a particular terminal 770, and enter a token using the terminal. In such an embodiment, the token verifying system recognizes the terminal for which the access should be granted by observing, from which terminal a user enters a token to the token verifying system. Consequently, the tokens need not contain information about a particular terminal, and need not be associated with information about a particular terminal before the token is used by the user.

According to a further aspect of the invention, a system for controlling access to a second network from a first network is provided. According to an advantageous embodiment of the invention, the system comprises at least

a verifying system 300 for receiving tokens and for verifying received tokens,

a gateway 750 connecting the first network to the second network, and

means 780 in said verifying system for controlling transmission of data packets from certain network addresses in the first network to recipients in the second network, and of data packets from the second network to certain network addresses in the first network.

According to a further advantageous embodiment of the invention, the system further comprises at least a base station 720 for communicating with wireless terminals.

According to a further advantageous embodiment of the invention, the system further comprises at least a terminal 770 fixedly connected to said first network.

According to a still further aspect of the invention, a method for providing connections to an external network from a first network is provided. This aspect of the invention is illustrated in FIG. 8. According to an advantageous embodiment of the invention, the method comprises at least steps of

receiving 810 a token,

checking 820 the validity of a token,

if a token was found valid, allowing 830 transmission of data packets to a certain network address of the first network from the external network and from said certain network address of the first network to the external network.

According to a further advantageous embodiment of the invention, the method further comprises the step of establishing 840 a radio link connection between the first network and a wireless terminal.

### I. Further Considerations

The present invention has several advantages. The invention allows the separation of the events of obtaining a right to do something and of using the right as is the case with conventional paper tickets. Many of the previously described embodiments do not require changes in presently existing mobile phones, i.e. many embodiments of the invention can be used with mobile phones, which are already on mass market at the time of writing of this patent application.

In the previous examples, the token issuing system and the token verification system were shown as being separate systems. However, in various embodiments of the invention, the token issuing system and the token verification system can be connected by a communication link for transferring information about tokens such as which tokens have been presented to the verification system. In some embodiments of the invention at least a part of the functionality of a token issuing system and a token verification system are implemented in the same physical device such as a computer.

The mobile communication means 200 can be a mobile phone, a mobile data terminal, a multifunctional mobile phone, or for example a mobile phone combined with PDA (personal digital assistant) functionality.

In the accompanying claims, the term right is intended to cover any right or benefit obtainable with the presentation of a ticket or a token, such as for example a right to see a show, obtain a product, enter a specific area, an so on.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

1. A system for granting and obtaining rights, characterized in that the system comprises
a token issuing system (100) for issuing tokens associated with specific rights,
means (110) for receiving token requests into the token issuing system (100) as orders given through a browser program, said requests requesting sending of tokens to mobile communication means (200) of users,
means (130) for transmission of tokens (10) from the token issuing system (100) to mobile communication means (200), and
a verifying system (300) for receiving tokens (10) from mobile communication means (200) and for verifying received tokens.

2. A system according to claim 1, characterized in that the verifying system (300) comprises means (320) for decrypting a received encrypted token.

3. A system according to claim 1, characterized in that the verifying system (300) comprises means (330) for verifying a digital signature in a received token.

4. A system according to claim 1, characterized in that the system comprises
a memory means (460) for storing descriptions of rights associated with tokens, and
in the verifying system (300), means for obtaining a description of a right from, said memory means (460) on the basis of a received token.

5. A system according to claim 1, characterized in at the verifying system (300) comprises means (440) for printing a ticket.

6. A method for granting and obtaining rights, characterized in that it comprises the steps of:
as a response to a user ordering a token with an order given through a browser program, generating (570) a token and transmitting (580) the generated token to mobile communication mean of a user,
receiving (500) a token associated with a right,
verifying (510) the received token, and
allowing (590) a user to obtain the right associated with the token.

7. A method according to claim 6, characterized in that it further comprises a step of verifying (530) a digital signature in a received token.

8. A method according to claim 6, characterized in that it further comprises a step of decrypting (520) a token.

9. A computer program element for a system for granting and obtaining rights, characterized in that it comprises
computer program code means for generating a token as a response to a user ordering a token with an order given through a browser program,
computer program code means for transmitting the generated token to mobile commutation means of a user,
computer program code means for receiving a token,
computer program code means for verifying a token, and
computer program code means for allowing a user to obtain the right associated with the token.
